(19) United States
(12) Patent Application Publication
(10) Pub. No.: US 2009/0277475 A1
(43) Pub. Date: Nov. 12, 2009

(54) PARTS WASHER

(76) Inventor: Earl Fenton Goddard, Western Australia (AU)

Correspondence Address: KLARQUIST SPARKMAN, LLP, 121 SW SALMON STREET, SUITE 1600, PORTLAND, OR, 97204, US

(21) Appl. No.: 12/279,485

(22) PCT Filed: Feb. 14, 2007
(86) PCT No.: PCT/AU2007/000159

§ 371 Date: Nov. 25, 2008

(30) Foreign Application Priority Data
Feb. 14, 2006 (AU) 2006900702

(51) Int. Cl. B08B 3/00

(52) U.S. Cl. 134/10; 134/110

(57) ABSTRACT

A parts washer comprises a cabinet defining a washing chamber and a tank for holding a volume of liquid. A fluid communication path extends between the tank and a discharge valve. During a normal wash cycle, cleaning fluid is drawn from the tank, passes through the communication path, and is returned to a manifold within the washing chamber to clean articles held therein. A separator is in fluid communication with the tank and separates contaminants from the liquid to produce clean liquid that flows back to the tank. A drain system allows draining of the separator to the tank and comprises a drain valve in fluid communication between the separator and a tank. An actuator system is coupled with the discharge valve and the drain valve to open the drain valve allowing the separator to drain to the tank and, opening the discharge valve allowing the tank (and thus the separator) to be purged via the discharge valve.

### CROSS REFERENCE TO RELATED APPLICATIONS

This is the U.S. National Stage of International Application No. PCT/AU2007/000159, filed Feb. 14, 2007, which was published in English under PCT Article 21(2), which in turn claims the benefit of Australian Patent Application No. 2006900702, filed Feb. 14, 2006. Both applications are incorporated herein by reference in their entirety.

### FIELD

The present invention is in relation to a parts washer particularly, although not exclusively, for washing mechanical parts and components such as may be found in an automotive repair workshop.

### BACKGROUND

The present inventor has been involved for many years in the design and construction of parts washing machines. A parts washing machine typically comprise a cabinet defining a washing chamber and a tank holding a volume of cleaning liquid. The liquid is drawn from the tank and sprayed via a manifold into the washing chamber to clean articles placed therein. The liquid then drains back into the tank. Contaminants such as oil that flow back into the tank during the washing process need to be removed from time to time. It is also preferable to completely purge the tank in order to maintain good washing standards.

It is known to provide a stand alone oil separator that is plumbed to the parts washer for the purposes of removing contaminants from the volume of cleaning liquid held within the tank. This assists in extending the time between the purging of the tank. Often, at that time the oil separator would also ordinarily be cleaned.

It is to be understood that, if any prior art publication is referred to herein, such reference does not constitute an admission that the publication forms a part of the common general knowledge in the art, in Australia or any other country.

In the claims of this application and in the description of the invention, except where the context requires otherwise due to express language or necessary implication, the words “comprise” or variations such as “comprises” or “comprising” are used in an inclusive sense, i.e., to specify the presence of the stated features but not to preclude the presence or addition of further features in various embodiments of the invention.

### SUMMARY

According to one aspect of the present invention there is provided a parts washer comprising:

a cabinet defining a washing chamber and a tank for holding a volume of liquid;

a fluid communication path extending between the tank and a discharge valve;

a separator in fluid communication with the tank, the separator operable to separate contaminants from the liquid to produce cleaned liquid that flows back to the tank;

a drain system to allow draining of the separator to the tank, the drain system comprising a drain valve controlling fluid communication between the separator and the tank; and,
an actuator system coupled with the discharge valve and the drain valve to open, the drain valve allowing the separator to drain to the tank and, the discharge valve allowing the tank to be purged by the discharge valve.

In one embodiment, the cabinet comprises a tank cover that forms, at least in part, a floor of the washing chamber, the tank cover being coupled with the actuator system, the tank cover movable between a wash position in which the tank cover overlies and closes the tank, and a service position where the tank cover is moved to allow access to an interior of the tank, the tank cover coupled with the actuator system in a manner to operate the actuator system to open the drain valve and the discharge valve when the tank cover is moved to the service position.

The parts washer may also comprise a return line providing fluid communication between the separator and the tank through which the cleaned liquid flows back up to the tank, the return line including a return valve to which the actuator system is coupled, wherein the actuator system opens the return valve when the drain valve is closed and closes the return valve when the drain valve is open.

Additionally the parts washer can have a contaminant line providing fluid communication between the separator and a contaminants reservoir, the contaminant line including a contaminant valve to which the actuator system is coupled, wherein the actuator system opens the contaminant valve when the drain valve is closed and closes the contaminant valve when the drain valve is open.

In one embodiment the fluid communication path comprises a first conduit, a pump, a second conduit, and a two way valve;

wherein the first conduit provides fluid communication between the tank and an inlet of the pump, the two way valve is in fluid communication with an outlet of the pump and has first and second ports, wherein the second conduit is connected to the first port and delivers liquid to the cabinet for washing articles therein, and the discharge valve is in fluid communication with the second port of the two way valve.

In the above embodiment the parts washer may comprise a lid that is pivoted between an open position allowing access to the washing chamber and a closed position closing the washing chamber; and, an actuator coupled to the two way valve and operated by changing the position of the lid between the open and closed positions, wherein when the lid is in the closed position the two way valve is in a wash position where the first port is open and the second port is closed, and when the lid is in the open position the actuator moves the two way valve to a service position where the first port is closed and the second port is open.

In the same or an alternate embodiment the separator may comprise a separator cleaning manifold disposed within the separator for directing fluid onto internal components and surfaces of the separator. A supply conduit may also be incorporated that provides fluid communication between the separator cleaning manifold and an inlet located inside of the cabinet, wherein when the lid is in the open position fluid can be directed into the inlet and supplied by the supply line to the separator cleaning manifold. Additionally the parts washer could comprise a hand held fluid gun plumbed to the pump between the pump outlet and the two way valve wherein cleaning liquid can be discharged by the hand held fluid gun.

According to another aspect of the present invention there is provided a method for servicing a parts washer comprising a cabinet defining a washing chamber and having a tank for holding a volume of liquid, and a fluid communication path between the tank and a discharge valve; the method comprising: coupling a separator in fluid communication with the tank wherein liquid from the tank is passed through the oil separator to produce cleaned liquid that is returned to the tank during a washing cycle of the parts washer;

providing a drain system allowing the separator to be drained to the tank;

opening the drain system wherein liquid and contaminants held within the separator flow into the tank; and,

discharging the tank via the discharge valve.

### BRIEF DESCRIPTION OF THE DRAWINGS

An embodiment of the present invention will now be described by way of example only with reference to the accompanying drawings in which:

FIG. 1 is a representation providing a perspective view of an embodiment of the parts washer having its lid in an open position;

FIG. 2 is a plan view of the parts washer shown in FIG. 1 but with its lid removed;

FIG. 3 is a further perspective view of the parts washer shown in FIGS. 1 and 2 but where a rotating platform and tank cover of the parts washer have been moved to a surface position;

FIG. 4 is a side view of the parts washer shown in FIG. 3;

FIG. 5 is an enlarged rear view of a portion of the parts washer shown in FIGS. 1-4;

FIG. 6 is an enlarged partial view of the washer from the side;

FIG. 7 is a further partial side view of the parts washer but with several components removed for greater clarity; and,

FIG. 8 illustrates aspects of mechanical connections and plumbing of the parts washer.

### DETAILED DESCRIPTION OF PREFERRED EMBODIMENT

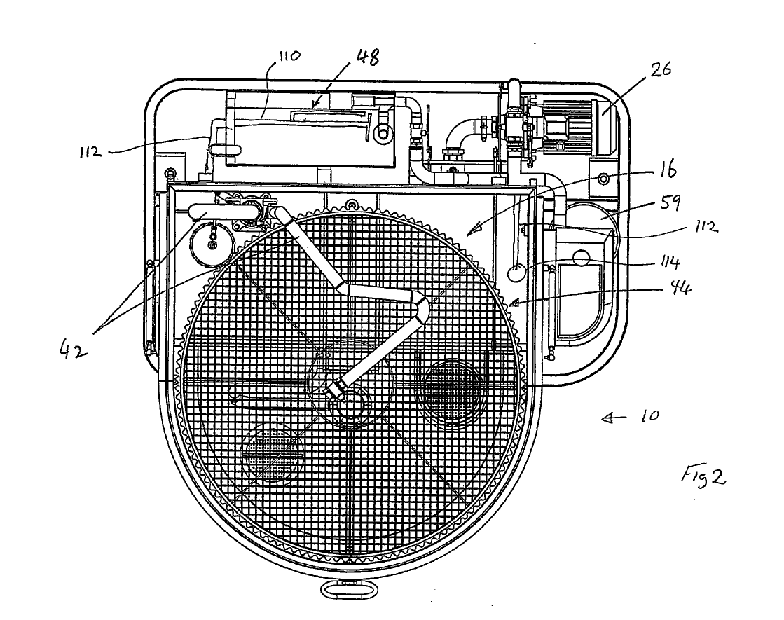

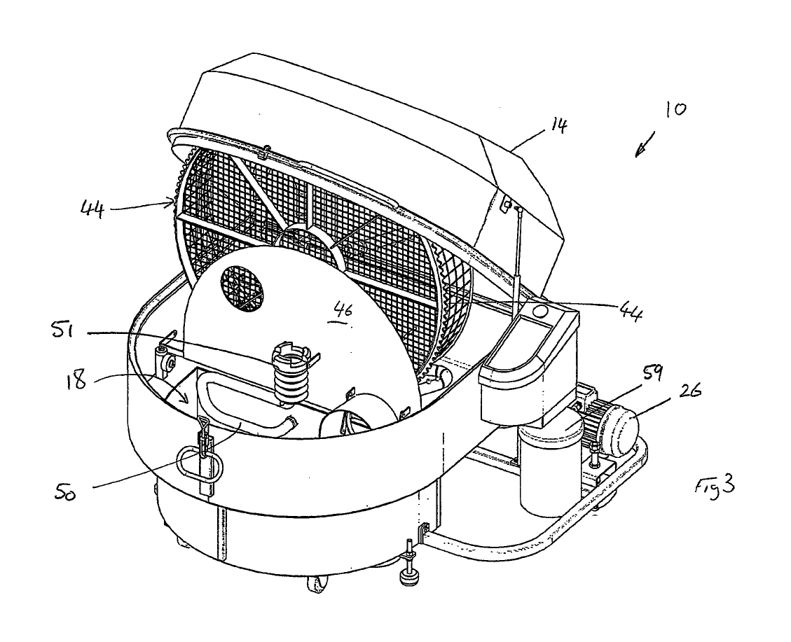

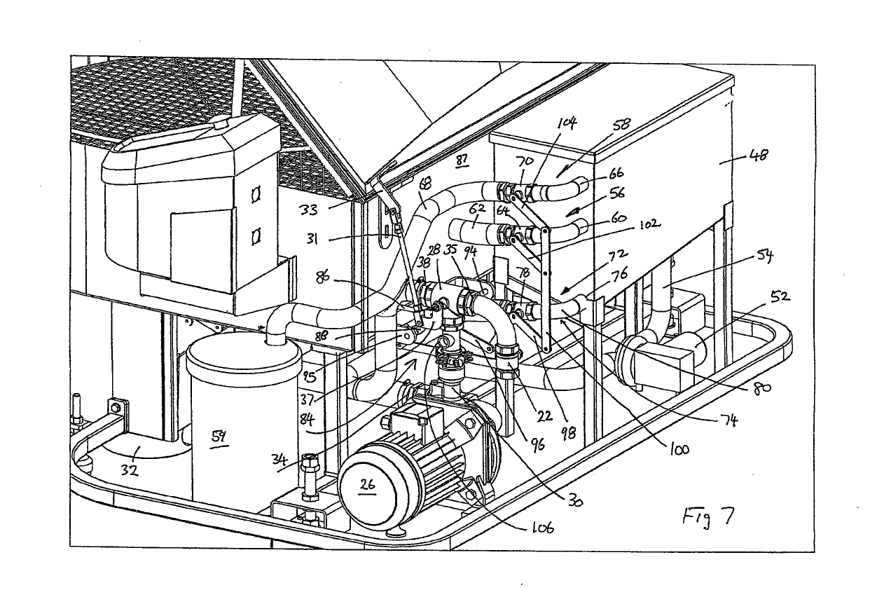

With reference to the accompanying drawings a parts washer 10 in accordance with an embodiment of the invention comprises a cabinet 12, that includes a pivoting lid 14, the cabinet 12 defining a washing chamber 16 in which articles to be cleaned are held, and a tank 18 (see in particular FIGS. 2 and 3) for holding a volume of liquid used to wash the parts. Typically the liquid is in the form of a mixture of water and detergent. As seen most clearly in FIG. 7, a fluid communication path 20 extends between the tank 18 and a discharge valve 22. The communication path 20 includes a conduit 24, a pump 26 and a two way valve 28 plumbed to an outlet 30 of the pump 26. The conduit 24 extends from a sump 32 of the tank 18 to an inlet 34 of the pump 26. The two way valve 28 has one port 35 connected to the discharge valve 22 via a conduit 36, and another port 38 connected to a conduit 40 that delivers liquid from the tank 18 to a spray manifold 42 disposed within the washing chamber 16.

A rod 31 is pivotally connected at one end to the lid 14 by an arm 33, and connected at an opposite end via an elbow lever 37 to the two way valve 28.

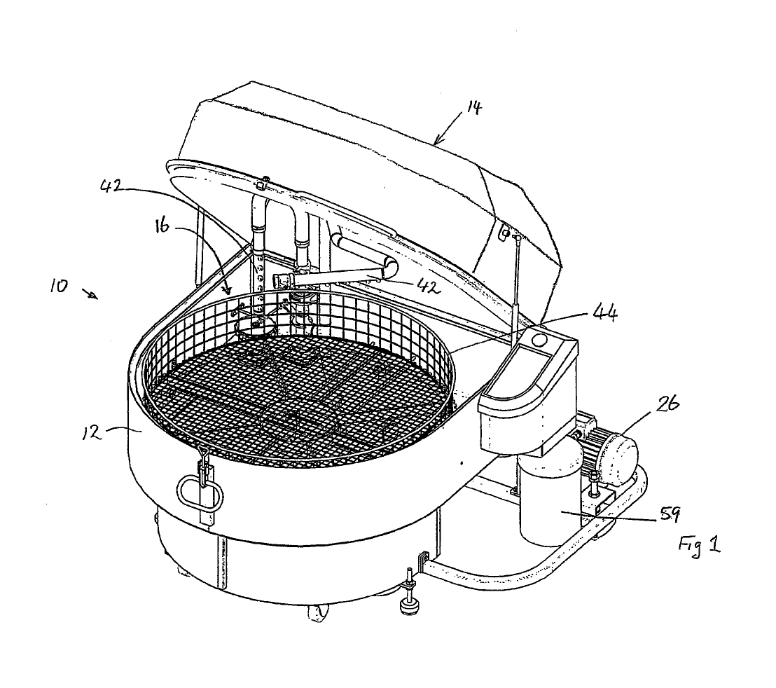

When the lid 14 is shut the rod 31 and level 37 move the valve 28 to a wash position where the valve 28 closes part 35 isolating the valve 22 and conduit 36, and allows liquid from the pump 26 to flow through port 38 and conduit 40 to the manifold 42. When the lid is moved to an open position, as depicted in FIGS. 1, 3, 4 and 5 the rod 31 and level 37 move the valve 28 to a service position where it closes port 38 isolating the conduit 40 from the pump 26, and opens port 35 directing liquid from the pump 26 through the conduit 36 to the discharge valve 22.

During a normal wash cycle the lid 14 is closed and valve 28 moved to the wash position by the rod 31 and the discharge valve 22 is in a closed position so that liquid drawn from the tank 18 through the conduit 24 and pump 26 is delivered to the spray manifold 42 via the conduits 28 and 40.

As shown in FIG. 2 a platform, in the form of an open top circular basket 44 is disposed within the washing chamber for supporting parts or other articles to be washed. The spray manifold 42 may be a movable manifold comprising a plurality of holes arranged to spray articles supported on or in the basket 44. The specific operation and construction of the manifold 42 and basket 44 is not material to the present invention. However examples of a manifold 42 and basket 44 that may be incorporated in embodiments of the present invention are described in Applicant's Australian provisional application number 2005905202 and International publication number WO 2004/091817, the contents of both of which are incorporated herein by way of reference.

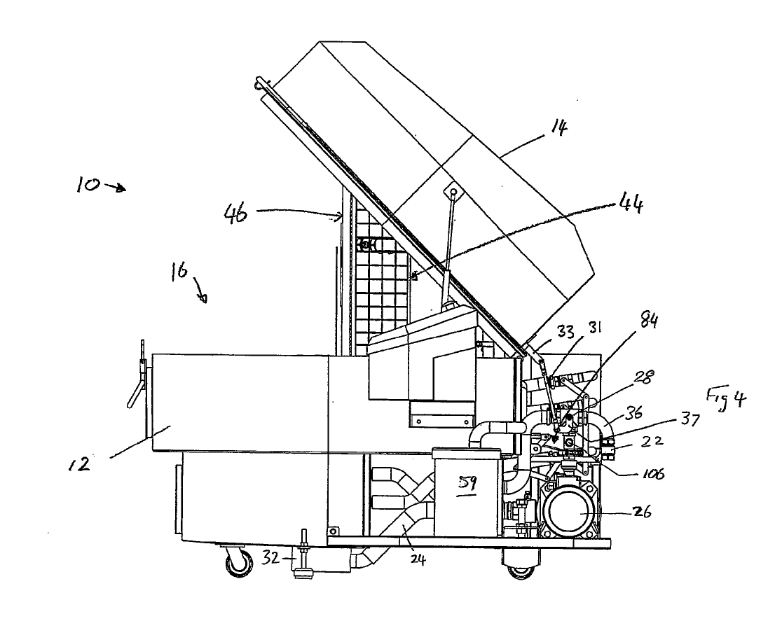

With particular reference to FIGS. 3 and 4, the tank 18 is provided with a tank cover 46 in the form of a D shaped plate that is pivoted between a closed or wash position in which the cover 46 overlies the tank, as shown in FIGS. 1 and 2, and a service position as shown in FIGS. 3 and 4 where the cover 46 is pivoted or otherwise moved away from the washing position to allow access to the interior of the tank 18.

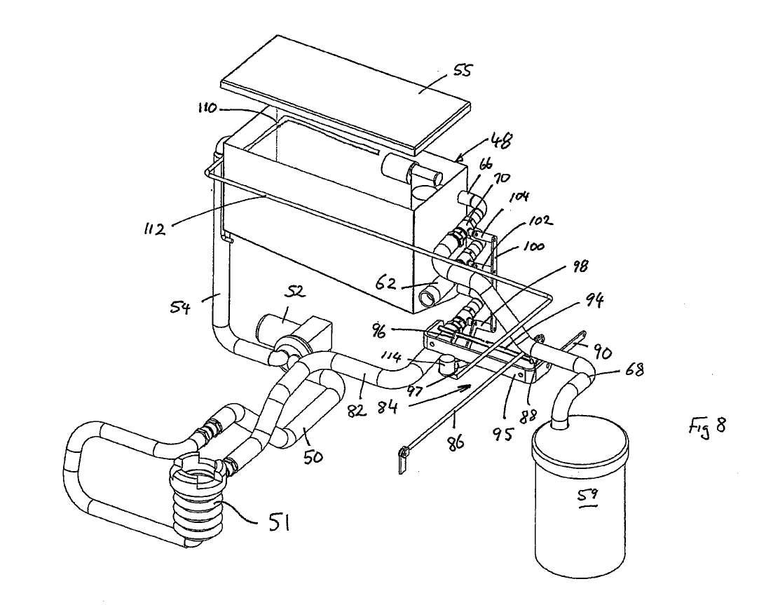

A separator 48 is in fluid communication with the tank 18 and operates to separate waste products and contaminants such as oil from the liquid to produce cleaned liquid that flows back to the tank 18. The fluid communication is provided by a conduit 50 that is plumbed between the tank 18 and a pump 52 with a further conduit 54 connected from the pump 52 to the separator 48. The pump 52 draws liquid from the tank 18 through the conduit 50 and pumps it into the separator 48 by the conduit 54. As shown in FIGS. 3 and 8 a floating head 51 may be attached to the conduit 50 inside of the tank 18 to skim oil and other contaminants floating on the cleaning liquid.

The separator 48 acts to separate waste products and contaminants such as oil from the liquid and returns cleaned liquid via a return line 56 (FIGS. 4 and 7) to the tank 18 while delivering the waste products and oil via a contaminant line 58 to a contaminant container 59. Many different types of commercially available separators that separate oil and other hydrocarbons from water can be used in various embodiments of the present invention. The specific form of the separator is not important to embodiments of the invention. The separator 48 has a lid 55 that can be removed or opened to allow access to the inside of the separator 48 and is provided with water and air tight seals, to seal the inside of the separator when the lid is closed. This will allow some degree of pressurization of the separator which may be of assistance during its cleaning/purging.

The return line 56 comprises an elbow pipe 60 plumbed to a side wall of the separator, a conduit 62 extending back to tank 18, and a valve 64 controlling fluid flow, between the pipe 60 and conduit 62 and thus, through the return line 56. Similarly the contaminant line 58 comprises an elbow pipe 66 plumbed to the side wall of the separator, a conduit 68 extending to the contaminant container 59, and a valve 70 controlling fluid flow, between the pipe 66 and conduit 68 and thus, through the contaminant line 56.

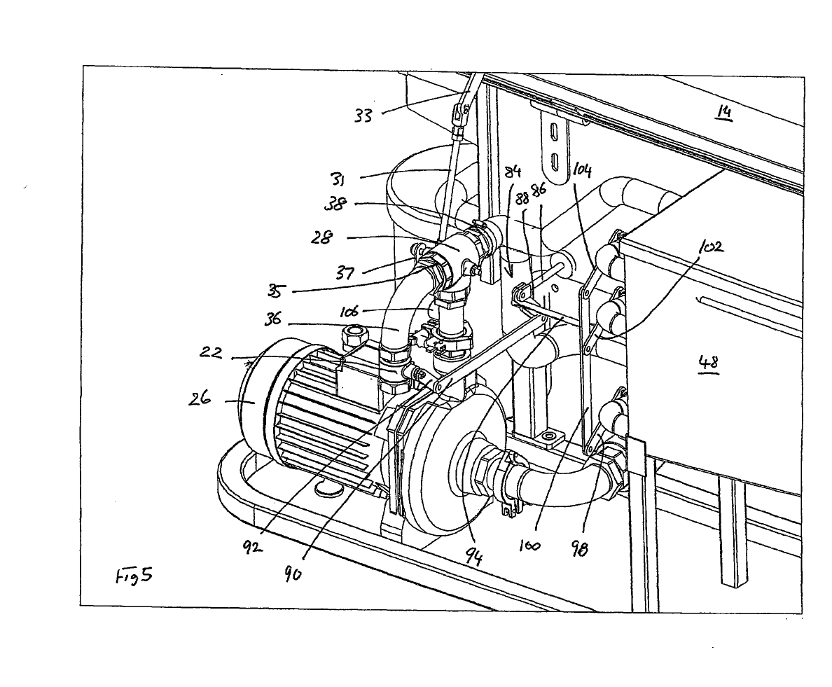

The parts washer 10 further comprises a drain system 72 to enable draining of the separator 48 during servicing and/or maintenance of the parts washer 10. The drain system 72 (see FIGS. 5 and 8) provides fluid communication between the separator 48 and the tank 18 and comprises a drain line 74 that extends from a drain outlet 76 at a lower corner of the separator 48 back to the tank 18, and a drain valve 78 within the drain line 74. More particularly the drain line 74 comprises an elbow pipe 80 and a conduit 82, with the valve 78 between the pipe 80 and conduit 82.

During the normal wash cycle of the parts washer 10, liquid is being circulated by the pump 26 from the tank 18 to the spray manifold 42. The pump 52 is typically activated when the pump 26 is OFF and circulates liquid from the tank 18 through the separator 48 to continuously clean the liquid, the valves 64 and 70 are open so that cleaned liquid is returned to the tank 18 via the return line 56 and oil and other waste products are delivered via the contaminant line 58 to the contaminant container 59, and the drain valve 78 is closed. The activation of the pump 52 may be on a timer basis or by computer control, e.g. to turn the pump 52 ON say 10 minutes after the completion of a wash cycle or outside of normal business hours e.g. after 9.00pm. While the pump 52 and thus the separator 48 can be activated during a wash cycle it is believed its efficiency would be reduced to agitation of liquid within the tank 18.

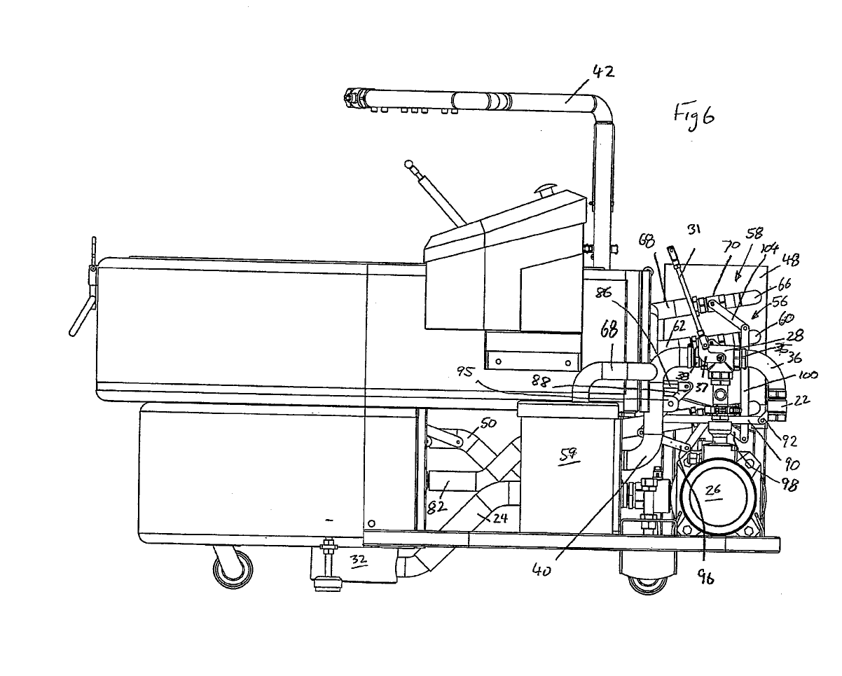

An actuator system 84 (see FIGS. 6 and 7) is coupled with the discharge valve 22 and the drain valve 78 to open the drain line 72 allowing the separator 48 to drain to the tank 18 and, to open the discharge valve 22 to allow the tank 18 to be purged via the discharge valve 22. The actuator system 84 is also coupled with the valve 64 in the return line 56, and the valve 70 in the contaminant line 58.

The actuator system 84 comprises a plurality of mechanical arms, rods and links that are coupled between the tank cover 46 and the valves 22, 78 (as well as valves 64 and 70) arranged so that when the tank cover 46 is moved to the service position, the valves 22 and 78 are opened allowing drainage of the separator 48 to the tank 18 and liquid from within the tank 18 to be purged or discharged when the pump 26 is turned ON and the lid 14 is open to move the two way valve 28 to the service position where port 38 is closes and port 35 is open.

The actuator system 84 comprises a rod 86 that passes through a rear wall 87 of the cabinet 12 and is connected at one end to the tank cover 46. An opposite end of the rod 86 is coupled to the valve 22 via sequentially connected links 88, 90 and 92 (see FIGS. 5, 6, 7 and 8). A rod 94 is journalled at opposite ends in a bracket 95 and fixed intermediate its length to the link 88, so that when the link 88 is pivoted by rod 86, the rod 94 rotates about its own longitudinal axis. The rod 94 is also attached to a lever 96 and then a link 97, which in turn is connected to a boomerang arm 98. A corner of the boomerang arm 98 is coupled to the valve 78, with an opposite end of boomerang arm connected to a vertically extending link 100. The link 100 is connected to an arm 102 that operates the valve 64, and an arm 104 that operates the valve 70.

When the tank cover 46 is moved to the service position, the arms, links and rod, 86, 88, 90, 92, 94, 96, 97, 98, 100, 102 and 104 that constitute the actuator system 84 move to open the valves 22 and 78, and close the valves 64 and 70. Obviously the lid 14 must first be opened in order to move the tank cover 46 to the service position. As explained above when the lid 14 is in the open position the valve 28 is moved to the service position.

With the valve 78 open, all fluids within the separator 48 flow by gravity into the tank 18. A time delay can be provided between the opening of the valve 78 and the operation of the pump 26. This is to allow all the fluids within the separator 48 to drain into the tank 18 prior to purging of the tank 18. The delay may be a simple operator delay between moving the tank cover 46 to the service position and operating a switch on the parts washer 10 to operate the pump 26; or alternately the delay can be built in by providing a time delay in the switch for turning on the pump 26. For example this could operate by incorporating a simple timer circuit in the switch used to operate the pump 26 so that once a switch is operated or depressed the timer counts a certain delay period before energizing the pump 26.

By virtue of the arrangement described above, greater efficiencies can be obtained in the servicing and/or maintenance of the parts washer 10 as both the separator 48 and the tank 18 may be purged and cleaned in a single operation with all liquids being purged or discharged via a common single discharge valve 22 and conduit 36. Once the separator 48 and tank 18 have been purged any remaining oil residue or waste products can be physically scraped and removed.

To further enhance cleaning of the separator 48, a manifold 110 (see FIGS. 2 and 8) can be provided in the separator 48 for directing liquid or air jets on to internal components of the separator 48 during servicing. In particular the manifold 110 may have a branch that directs liquid/air jet onto a bottom surface of the separator to blast deposits laying on the bottom toward the outlet 76, and a branch to direct liquid/air jefts onto an oil pickup belt or disc, or other oil separating structure inside the separator 48. The manifold may have an inlet plumbed via a supply line or conduit 112 to the cabinet 16 and having an inlet 114 for receiving a nozzle of a hand held fluid, i.e. liquid/air dispensing gun that is in fluid communication with the outlet 30 via a port 106. When the pump 26 is operated, irrespective of the position of the valve 22, liquid will be provided at the port 106. Therefore the manifold 110 of the separator 48 may be charged with liquid via the hand held gun during the normal washing cycle of the parts washer, or during the service cycle. To provide air to the manifold of the separator 48, the gun may be separately connected to an air compressor, or simply include a venturi valve or opening to allow air to be drawn into the liquid.

Now that an embodiment of the present invention has been described in detail it will be apparent to those skilled in the relevant arts that numerous modifications and variations may be made without departing from the basic inventive concepts. For example the actuator system 84 is depicted as being in the form of a mechanical linkage however any other actuator system that achieves the same effect can be used, for example an electric switch may be used to power solenoids for operating the valves, the switch itself being actuated by moving the tank cover from the wash position to the service position.

All such modifications and variations are deemed to be within the scope of the present invention the nature of which is to be determined from the above description and the appended claims.

1. A parts washer comprising:
a cabinet defining a washing chamber and a tank for holding a volume of liquid;
a fluid communication path extending between the tank and a discharge valve;
a separator in fluid communication with the tank, the separator operable to separate contaminants from the liquid to produce cleaned liquid that flows back to the tank;
a drain system to allow draining of the separator to the tank, the drain system comprising a drain valve controlling fluid communication between the separator and the tank; and,
an actuator system coupled with the discharge valve and the drain valve to open, the drain valve allowing the separator to drain to the tank and, the discharge valve allowing the tank to be purged by the discharge valve.

2. The parts washer according to claim 1 wherein the cabinet comprises a tank cover that forms, at least in part, a floor of the washing chamber, the tank cover being coupled with the actuator system, the tank cover movable between a wash position in which the tank cover overlies and closes the tank, and a service position where the tank cover is moved to allow access to an interior of the tank, the tank cover coupled with the actuator system in a manner to operate the actuator system to open the drain valve and the discharge valve when the tank cover is moved to the service position.

3. The parts washer according to claim 1 further comprising a return line providing fluid communication between the separator and the tank through which the cleaned liquid flows back up to the tank, the return line including a return valve to which the actuator system is coupled, wherein the actuator system opens the return valve when the drain valve is closed and closes the return valve when the drain valve is open.

4. The parts washer according to claim 1 further comprising a contaminant line providing fluid communication between the separator and a contaminants reservoir, the contaminant line including a contaminant valve to which the actuator system is coupled, wherein the actuator system opens the contaminant valve when the drain valve is closed and closes the contaminant valve when the drain valve is open.

5. The parts washer according to claim 2 wherein the fluid communication path comprises a first conduit, a pump, a second conduit, and a two way valve;
wherein the first conduit provides fluid communication between the tank and an inlet of the pump, the two way valve is in fluid communication with an outlet of the pump and has first and second ports, wherein the second conduit is connected to the first port and delivers liquid to the cabinet for washing articles therein, and the discharge valve is in fluid communication with the second port of the two way valve.

6. The parts washer according to claim 5 further comprising a lid that is pivoted between an open position allowing access to the washing chamber and a closed position closing the washing chamber; and, an actuator coupled to the two way valve and operated by changing the position of the lid between the open and closed positions, wherein when the lid is in the closed position the two way valve is in a wash position where the first port is open and the second port is closed, and when the lid is in the open position the actuator moves the two way valve to a service position where the first port is closed and the second port is open.

7. The parts washer according to claim 6 further comprising a separator cleaning manifold disposed within the separator for directing fluid onto internal components and surfaces of the separator.

8. The parts washer according to claim 7 further comprising a supply conduit providing fluid communication between the separator cleaning manifold and an inlet located inside of the cabinet, wherein when the lid is in the open position fluid can be directed into the inlet and supplied by the supply line to the separator cleaning manifold.

9. The parts washer according to claim 7 further comprising a hand held fluid gun plumbed to the pump between the pump outlet and the two way valve wherein cleaning liquid can be discharged by the hand held fluid gun.

10. A method for servicing a parts washer comprising a cabinet defining a washing chamber and having a tank for holding a volume of liquid, and a fluid communication path between the tank and a discharge valve; the method comprising: coupling a separator in fluid communication with the tank wherein liquid from the tank is passed through the oil separator to produce cleaned liquid that is returned to the tank during a wash cycle of the parts washer;
providing a drain system allowing the separator to be drained to the tank;
opening the drain system wherein liquid and contaminants held within the separator flow into the tank; and,
discharging the tank via the discharge valve.
